(19) United States
(12) Patent Application Publication
(10) Pub. No.: US 2025/0034045 A1
(43) Pub. Date: Jan. 30, 2025

(54) METHODS OF PRODUCING MINERAL BASED MATERIAL

(71) Applicant: Biozeroc Ltd, Cambridge (GB)

(72) Inventors: John Matthew SOMERVILLE, Cambridge (GB); Liv Amelia ANDERSSON, Cambridge (GB); Fanny YUEN, Cambridge (GB); Davor IVANKOVIC, Cambridge (GB); Laurence DE LUSSY KUBISA, Cambridge (GB)

(21) Appl. No.: 18/716,758

(22) PCT Filed: Dec. 5, 2022
(86) PCT No.: PCT/GB2022/053091

§ 371 Date: Jun. 5, 2024

(30) Foreign Application Priority Data
Dec. 5, 2021 (GB) 2117565.8

(51) Int. Cl. C04B 28/10; C04B 40/02; C04B 103/00

(52) U.S. Cl. CPC C04B 28/10; C04B 40/0259; C04B 2103/0001

(57) ABSTRACT

A method of using microbial methods to form mineral based material elements via the precipitation of calcium-carbonate into an element composed primarily of aggregate is provided. Pressure is applied across at least part of the element being produced in order to drive a bulk flow of a liquid containing nutrients at least partly through the element to the bacteria. Structures in the element may be used to enhance transfer of reagents and nutrients to the microbes within the material.

### FIELD

This application relates to using microbial methods to form mineral based material elements.

### BACKGROUND

Construction materials are widely used and approximately 40% of global CO₂ emissions are related to the construction industry. Materials such as wood and straw have the potential to be carbon negative particularly in smaller structures but are limited in their application to larger structures. In larger structures engineered wood materials such as Cross Laminated Timber (CLT) have been explored and have potential, however compared to concrete based materials the additional volume and thickness of CLT elements can result in reduced floor space for a given building envelope. There are also significant considerations with respect to deforestation, fire and sound transmission.

There are many lower carbon concrete additions or substitute cements available some of which require only minor changes to the concrete casting process. However, such approaches typically cannot achieve the highest strengths of concrete and remain the cause of significant carbon dioxide emissions so are not zero CO₂ emissions. Even more significantly these approaches require the use of industrial byproducts such as fly ash or ground granulated blast furnace slag (GGBFS or GGBS) which are already insufficient for global demand, incur significant transport costs and emissions and are expected to decline in availability over the coming years as coal power is phased out and steel is increasingly recycled.

The technique of Microbially Induced Calcite Precipitation (MICP) is known per se to those skilled in the art as a method of cementing together particles with calcium-carbonate which is also known as CaCO₃ or calcite and has been used for a variety of applications.

For example FR8903517 (1994) deals with repairing surfaces by placing mineralizing microorganisms on artificial surfaces in conditions which ensure mineralization. The use of bacteria in self-healing concrete is described in this journal article ‘Application of bacteria as self-healing agent for the development of sustainable concrete’ (Ecological Engineering Volume 36, Issue 2, February 2010, Pages 230-235). Use of bacillus pasteurii bacteria for stabilising sand columns is described in ‘Microbiological precipitation of CaCO₃’ (Soil Biology and Biochemistry; Volume 31, Issue 11, October 1999, Pages 1563-1571). EP2563739B1 describes how to make relatively thin solid structures such as bricks and tiles.

However, these approaches are not optimal for creating larger or higher strength products, and when applied to such will either produce insufficient strength or take a prohibitively long time to achieve this. There therefore remains a need for methods in which MICP is used to produce construction materials.

### SUMMARY

The application relates particularly to the creation of elements for use, for example, in construction.

According to a first aspect of the present invention, there is provided a method of producing an element comprising an aggregate matrix and calcium-carbonate, wherein the calcium-carbonate is precipitated by bacteria into the element being produced. The method comprises applying a pressure across at least part of the element being produced in order to drive bulk flow of a liquid containing nutrients at least partly through the element. By driving the nutrient-containing liquid through the element using bulk flow, nutrients may be delivered to bacteria throughout the element thereby preventing or minimising the lower strength core that is often observed in prior art methods.

Structures may be utilised to facilitate transfer of reagents and nutrients to the bacteria within the construction material so enabling the creation of elements that could not otherwise be easily fabricated in a timely or cost-effective manner. Thus, the method of the present invention may comprise providing the element being produced with a structure to facilitate flow of a liquid containing nutrients to the bacteria. These structures may be internal to the element (such as engineered voids) or external to the element (such as nutrient distribution channels that form part of a manifold).

This can enable an improved method for the fabrication of construction elements that have low, zero or negative CO₂e emissions by microbial deposition of calcium-carbonate also known as Microbially Induced Calcite Precipitation (MICP). Through the inclusion of hollow structures also referred to as engineered voids within the construction elements that facilitate enhanced nutrient flow to the construction element during fabrication, the fabrication of much larger structures and acceleration of the fabrication process can be enabled.

Another potential advantage is that these hollow structures may also provide construction elements that are strong, lightweight and stiff when compared to previous solid MICP fabrication approaches and may also enable post tensioning of the structures to maintain the construction elements under compression.

MICP, also known as biocementation, typically uses urea and a source of calcium ions such as calcium chloride to feed bacteria such as Sporosarcina pasteurii which produce urease catalysing the below reaction.

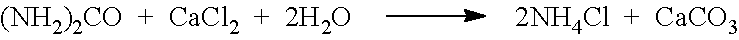

In methods of the present invention, a liquid containing nutrients is flowed to bacteria in the element being formed thereby enhancing the rate of biocementation. The nutrients may be starting materials in the biocementation reaction, they may catalyse the process or be a building block for a catalyst, they may help the bacteria to multiply, and/or they may enhance the rate of biocementation in a bacterium. Nutrients may include but are not limited to reagents such as urea (preferably obtained from human or animal urine), calcium chloride, calcium nitrate, NiCl₂, NaOH, ammonium chloride, yeast extract, autolysed yeast, waste treatment sludge, corn steep liquor, tris(hydroxymethyl)aminomethane, tryptone, tryptic soy broth, saccharides (in particular monosaccharides such as D-glucose and sucrose), and peptone water (preferably derived as a waste product from meat). Preferably, a combination of nutrients is provided to the bacteria.

The liquid in which the nutrients are delivered to the bacteria will typically be water. Thus, the liquid containing nutrients will generally be an aqueous nutrient solution.

To form a bio-concrete through MICP or biocementation the calcium-carbonate is precipitated into an aggregate matrix. Since biocementation is a gradual process, in methods of the present invention the element gradually forms around the aggregate matrix; the terms “aggregate matrix” and “element” may therefore both be used to denote the element while it is being formed.

The aggregates used in the aggregate matrix may comprise or consist of inert granular materials such as sand, gravel, rock, slag, recycled aggregate such as recycled concrete, carbon sequestering materials such as synthetic aggregates made from captured CO₂ or biochar, geosynthetic materials and combinations thereof. Because the matrix is composed of aggregate, it is by nature porous to the nutrient-containing liquid.

Techniques such as crushing and/or grading may be used to obtain the aggregates with a desired particle size and shape distribution for a given application. Thus, in some embodiments, the method of the present invention may comprise a step of crushing and/or grading the aggregate before it is used in the aggregate matrix. However, pre-crushed and/or graded materials will generally be used.

The method of the present invention may be carried out using a wide range of aggregate sizes. The aggregate size may be at least 0.01 mm, preferably at least 0.075 mm, and more preferably at least 0.154 mm. The aggregate size may be up to 19 mm, preferably up to 6.3 mm, and more preferably up to 3.2 mm. Thus, the aggregate size may be from 0.01 to 19 mm, preferably from 0.075 to 6.3 mm, and more preferably from 0.154 to 3.2 mm, though it will be appreciated that smaller and larger aggregate sizes may also be used. These particle sizes have been shown to be particularly effective at providing sufficient porosity for the nutrient-containing liquid to flow through the element being produced, while achieving good interlocking between the aggregates. The particle sizes described herein may be determined using standard sieving methods, such as outlined in ASTM E11-22, whereby particles that pass through a sieve with an aperture size of x have a particle size of less than x and those that do not pass through the sieve have a particle of greater than x.

As will be apparent to those skilled in the art, materials other than calcium-carbonate may be deposited by suitable bacteria or alternative metal ion sources. For instance, a magnesium ion source allows the deposition of magnesium carbonate in the element being produced.

When forming thicker sections using previously described approaches (e.g. as referred to above), there is often insufficient flow of reagents and nutrients as well as insufficient opportunity to remove reaction byproducts from the aggregate matrix leading to difficulty in forming consistent strength over thicker sections. This difficulty is exacerbated as the targeted strength of the biocementation process increases due to the reduced porosity associated with higher strength structures.

The method of the present invention may use an aggregate media in combination with structures in the elements to facilitate greater reagent supply and byproduct removal to the aggregate matrix and the bacteria. This can enable larger structures, thicker sections, internal structures and higher strength to be achieved more rapidly.

An element that is produced using a method of the present invention may have a region with a thickness of greater than 50 mm, preferably greater than 100 mm, more preferably greater than 150 mm, such as greater than 200 mm or even 300 mm. The element will generally not contain a region with a thickness of greater than 450 mm. It will be appreciated that the “thickness” in the context of a region or wall of the element means the distance between two surfaces. This may be two external surfaces where for instance the element does not contain internal voids, an internal and external surface where the element contains an internal void, or two internal surfaces where the element contains more than one internal void.

Different thicknesses may be measured for each point on the (internal or external) surface of the element. This is because from any given point, a line may be drawn to multiple points on another surface. For the avoidance of doubt, for purposes of the present invention, “thickness” in the context of a region or wall of the element means the minimum distance to another surface.

In preferred embodiments, the thicknesses of different regions within an element are similar to one another as this helps to provide even levels of MICP throughout the element. Thus, the thicknesses of different regions within an element are all preferably within 50 mm of one another, more preferably within 40 mm of one another, and still more preferably within 30 mm of one another.

An element that is produced using a method of the present invention preferably has the shape of a cuboid (e.g. a rectangular cuboid) or a cylinder (e.g. hollow like a tube, or solid like a column), since these shapes are useful in construction. Cuboids shapes such as blocks or sheets are particularly preferred. It will be appreciated that an element that is produced using a method of the present invention may contain internal voids or other structures and, as such, does not have to be solid.

As well as having region thicknesses, an element that is produced in accordance with the present invention has an overall thickness, which represents the distance between the external, typically opposed and/or planar, surfaces through which the nutrient-containing liquid flows into and/or out of the element being formed.

The method of the present invention may be used to prepare elements having a wide variety of sizes. However, it is particularly suitable for preparing elements having an overall thickness of at least 65 mm, preferably at least 100 mm, more preferably at least 200 mm, such as at least 300 mm. Even greater thicknesses may be achieved by the use of engineered voids which can enhance the element thickness without adding to the aggregate material through which the nutrient-containing liquid must flow. An element may be produced having a wide variety of lengths and widths (i.e. the dimensions perpendicular to the thickness), for instance from 100 mm to 2 m.

The method of the present invention comprises applying a pressure across parts of the element so driving a bulk flow of nutrient-containing liquid through the aggregate. The term ‘bulk flow’ is used to differentiate the net flow of a liquid driven by a differential pressure from the ‘diffusive flow’ of elements within the liquid that would occur even in the absence of an applied pressure. It will be appreciated that when bulk flow is used, some diffusive flow will nonetheless be taking place in the element being formed.

The bulk flow of the nutrient-containing liquid is preferably driven into a first surface of the element being formed, through the element being formed, and out of a second surface of the element being formed. For instance, the bulk flow of the nutrient-containing liquid to be driven into and out of the element being formed through external, preferably opposed, surfaces or through an external and an internal surface. It will be appreciated that the nutrient-containing liquid will be depleted of some nutrients once is has passed out of the element being formed.

The pressure that is used to drive the bulk flow is preferably at least 1 kPa, more preferably at least 5 kPa, and still more preferably at least 10 kPa. The pressure that is used to drive the bulk flow is preferably up to 100 kPa, more preferably up to 50 kPa, and still more preferably up to 30 kPa. Thus, the pressure that is used to drive the bulk flow is preferably from 1 to 100 kPa, more preferably from 5 to 50 kPa, and still more preferably from 10 to 30 kPa. It will be understood that these values represent the pressure of liquid that is applied at the surface through which the nutrient-containing liquid is passed into the element being formed. Typically, the pressure at the surface through which the nutrient-containing liquid flows out of the element being formed will be much less.

The bacterial cells catalysing the calcium-carbonate precipitation may be added with the nutrient-containing liquid or mixed into the aggregate before it is placed into the desired element shape. In some embodiments, cells may be added with both the nutrient-containing liquid and as part of the aggregate matrix. Whichever method is used to position the cells in the desired location within the aggregate, a steady supply of nutrients can encourage them to multiply so further accelerating the deposition process.

To retain the aggregate while the pressure is applied, one or more perforate or porous moulds may be used that allow the nutrient-containing liquid to flow through the element while retaining the aggregate. The perforations or holes in the mould are preferably large enough to allow the nutrient-containing liquid to enter and exit the mould, but small enough to retain the aggregate in the matrix. For instance, the mould may comprise perforations or holes having a diameter of at least 25 μm, preferably at least 50 μm, and more preferably at least 75 μm.

These sizes are large enough for a good level of nutrient-containing liquid to flow into the mould. The mould may comprise perforations or holes having a diameter of up to 175 μm, preferably up to 150 μm, and more preferably up to 125 μm. These sizes are small enough to retain a good proportion of the aggregate in the mould, though larger size may also be suitable, such as up to 400 μm. Thus, the mould may comprise perforations or holes having a diameter of from 25 to 175 μm, preferably from 50 to 150 μm, and more preferably from 75 to 125 μm.

Although perforate or porous moulds are preferred, any structure comprising a material (e.g. a porous or solid material) may be provided on one or more surfaces of the element being produced. The material preferably serves to at least partly retain the aggregate matrix during production of the element.

The perforate or porous mould may surround at least part of the aggregate matrix, and preferably the entire aggregate matrix. Where the mould surrounds the entire aggregate matrix, it may be perforate or porous over the entire mould, or just over certain areas. For instance, the mould may comprise, e.g. opposing, perforate or porous faces through which the nutrient-containing liquid enters and exits the mould, with the remainder of the mould surfaces being solid.

Alternatively, and as discussed in greater detail below, one or more perforate or porous moulds may sit within the aggregate matrix so that one or more engineered voids are present in the element. Preferably, when a perforate or porous mould sits within the aggregate matrix, a perforate or porous mould will also surround the aggregate matrix. A single mould may also be used to surround and form voids within the aggregate matrix.

The perforate or porous mould can be designed to easily come away from the element under manufacture. However, it is generally preferred for the mould to be retained within the element. As will be appreciated, retaining the mould in the exterior of the construction element can create a composite structure so resulting in various advantages such as but not limited to: improved strength and stiffness of the completed element, improved visual appearance and improved ability to accept subsequent finishes such as render or screed. Other forms of reinforcing structure are discussed in greater detail below.

The perforate or porous mould may be formed from materials such as perforate sheets, sintered elements, woven/knitted mesh or non-woven fibrous media. Particularly preferred are matts, weaves or fibres made of glass, basalt, carbon or nylon.

Perforate sheets may be produced by techniques such as etching, electroforming, stamping, laser machining or conventional machining and would be expected to give the highest degree to control over the aperture dimensions. Perforate sheets may be made from metal (such as steel), ceramic, plastic, but will preferably be metal. Sintered elements are formed from metal, ceramic, plastic or mineral pressed together using either heat or pressure. Woven\knitted mesh is typically formed from one or more filaments woven or knitted together to create relatively consistent open apertures and could be composed of fibres/wires of metals, plastics, glass, basalt, carbon or organic material such as wool, cotton, grass or hemp. Non-woven materials are typically fibres pressed together in a less ordered fashion where the fibres can include wood pulp, polymer, glass, basalt, carbon or metal.

It may be advantageous to carry additional cells into the aggregate entrained in the nutrient flow in which case the perforate or porous mould will require perforations or hole sizes that are greater than the diameter of the bacteria and ideally more than ten times greater. In these embodiments, the mould may comprise perforations or holes having a diameter of more than 0.2 μm.

In some embodiments, the perforate or porous mould may have openings small enough to retain bacteria within the element under fabrication. In these embodiments, the perforations or holes that are present in the mould preferably have a diameter of less than 0.2 μm, such as up to 0.1 μm. However, these embodiments are generally less preferred since they result in a lower level of flow of the nutrient-containing liquid into the mould.

The perforate or porous mould may also be engineered such that it acts to direct the nutrient flow to critical regions within the element being fabricated. Such tailoring of the flow resistance of the perforate or porous mould can be achieved by using different pore sizes, densities, spacings or path lengths, or for example by using different perforate media in different regions, layering perforate media or by selectively compressing a single sheet of the perforate media to reduce or eliminate the pores in certain regions. This approach can be used to achieve uniform calcium-carbonate deposition through different sections, where for instance the element that is being formed has regions of different thicknesses, or to create additional deposition in critical areas. It will be appreciated that uniform deposition is intended to mean more uniform than that achieved in a mould in which the flow resistance of different regions has not been tailored. This is advantageous as the amount of deposited material within the construction element is approximately proportional to the element's strength so it can be disadvantageous to leave weaker regions.

In the event that the bacteria are photosynthetic the same structures that are used to convey nutrients to the construction element can also be used to facilitate the delivery of light. Thus, in some embodiments, the method may comprise introducing lights into the engineered void.

In some examples, the aggregate matrix is held together by a binder enabling sufficient strength to be achieved for the element prior to further processes. Thus, the method of the present invention may comprise partly forming the aggregate matrix into the element using a binder prior to the bacterial precipitation of the calcium-carbonate. The part forming of the aggregate matrix may be done in a mould in the shape of the desired construction element.

The binder is preferably used at a low concentration, for instance in an amount of up to 10%, and preferably up to 5%, by volume.

The use of a binder generally means that a porous or perforate mould is not required to retain the aggregate in the matrix, though in some instances both a binder and mould may be used. The use of a binder also allows the processing to form the element's initial shape to be achieved with standard equipment. Where a binder is not used, then the aggregate is preferably held in place, for instance by a mould, for substantially all of the MICP process.

The binder may be chosen from a range of materials such as hydrogels, polymeric adhesives, cements or alternative cement replacements such as fly-ash, silica, ground granulated blast-furnace slag (GGBS), a geopolymer or biocementation. A waste product from the method of the present invention may also be used as the binder. For instance, calcium-carbonate that is present in the nutrient-containing liquid after it has flowed through at least part of the element being produced could be used to bind the aggregate matrix.

In the simplest form the pressure may be through the element where the shape of the element forms a simple structure of a block or sheet, such as a solid block or sheet. In these instances, the structure that facilitates the flow of nutrient-containing liquid may be an external structure such as a flow distribution manifold.

In some examples, there are engineered voids within the element. The voids within the element may be formed by suitable positioning of the perforate or porous moulds within the aggregate matrix and the element as it forms. Though less preferred, the voids may also be formed by positioning moulds having solid walls (i.e. non-porous and non-perforated) within the aggregate matrix and the element as it forms. These solid-walled moulds will typically be hollow so as to create hollow blocks.

In some examples, there may be just one engineered void within the element. In other examples, there are multiple engineered voids within the element. For instance, there may be at least 2, or at least 3, voids within the element, though in practice still greater numbers of voids may be present. Preferably, one or more engineered voids are positioned in the element such that the walls of the element have a thickness of at least 30 mm, preferably at least 60 mm, and more preferably at least 80 mm in thickness. Preferably, one or more engineered voids are positioned in the element such that the walls of the element have a thickness of up to 300 mm, preferably up to 270 mm, and more preferably up to 250 mm in thickness. Thus, one or more engineered voids may be positioned in the element such that the walls of the element have a thickness of from 30 to 300 mm, preferably from 60 to 270 mm, and more preferably from 80 to 250 mm in thickness. Preferably all of the walls in the element have a thickness as outlined above.

Where there are engineered voids within the element that are formed from perforate or porous moulds, pressure may be used to drive the flow to or from these engineered voids through the external walls of the element. This approach can be used to create structures such as hollow blocks.

Where there are multiple engineered voids within the element, the pressures within these engineered voids are selected to drive the flow to or from these engineered voids through the external and internal walls of the element. In such examples, it may be advantageous that the pressures within these multiple engineered voids are not equal through the entire process. For instance, the pressures may be unequal to facilitate nutrient flow through the internal walls of the structure. This creates higher strength regions between the voids in the element being produced. Unequal pressures may be achieved using a perforate or porous mould, as described above, that has been engineered such that it acts to direct the nutrient flow to critical regions within the element being fabricated.

In some examples, to accelerate the deposition process, suspensions of calcium-carbonate, and preferably fine suspensions of calcium-carbonate, are supplied with the nutrient flow. This greatly accelerates the deposition of calcium-carbonate within the porous matrix. As will be explained in greater detail below, the calcium-carbonate suspension may be a recycled stream from the deposition process.

The pressure used to drive the nutrient flow can be generated in many ways which will be apparent to those skilled in the art, such as by liquid pumps applying pressure to the nutrient-containing liquid or by gas pumps applying pressure to headspace above the nutrient-containing liquid. The term pressure is used to mean either pressure or vacuum. Simple low-cost ways of applying the pressure may include hydrostatic pressure, pressure from an air compressor or by directly pumping the fluid into a closed volume. In some embodiments, the pressure that drives the flow of the liquid is applied so as to place one or more regions of the aggregate matrix within the element being produced under compression during biocementation.

In some examples, the nutrient-containing liquid is recycled back to the element being produced. It will be appreciated that the levels of nutrients in the nutrient-containing liquid will reduce as it is recycled, though they may also be replenished with each recycle loop. The recycling may comprise recycling the nutrient-containing liquid back to the element being formed without removing components, such as particles, from the liquid.

However, when pumping and managing a nutrient-containing liquid prone to calcium-carbonate deposition (also known as biocalcification) it is advantageous to manage calcium-carbonate precipitation within the liquid itself before this settles out, damaging equipment and wasting reagents. This can be achieved by the use of a separation device such as hydrocyclone, virtual impactor or crossflow filter that separates the liquid plus suspension into two flows based on the particle sizes. The smaller particulates can continue to circulate and be filtered out by the aggregate adding density and strength to the element while the larger particles can either be added to elements earlier in the calcification process, mixed into aggregate prior to starting the growth, recycled or deposited into the inside of the element to maintain external dimensions and finish.

Thus, in some examples, the method of the present invention comprises separating the nutrient-containing liquid into two streams after it has flowed through at least part of the element being produced. The separation is typically based on the particle size of the precipitate, and produces a first stream and a second stream, where the particle size in the first stream is larger than that in the second stream. For instance, the nutrient-containing liquid may be separated into a first stream containing particles of greater than a target size (e.g. falling in the range of from 1 to 25 μm), and a second stream containing particles of up to the target size. In some instances, as the element is being formed and its porosity decreases, the target size reduces. For instance, at the start of the method the target size may be fall in the range of from 10 to 25 μm and at the end of the method from 1 to 10 μm.

The first stream may be seen as a coarse particle stream (or a waste stream, albeit with the waste preferable reused). For instance, the method of the present invention may comprise incorporating the precipitates from the first stream into an aggregate matrix as aggregate and/or a binder in the matrix. This is particularly suitable for a course stream containing particle sizes of greater than 50 μm, and preferably greater than 100 μm. The aggregate matrix may then be used to prepare a further element comprising an aggregate matrix and calcium-carbonate, for instance using a method of the present invention. Thus, the waste flow may be used in the fabrication of another element being produced at an earlier stage of the bacterial precipitation of calcium-carbonate.

The second stream may be seen as a fine stream and is preferably recycled back to the element being produced to accelerate the deposition process. The second stream preferably comprises a suspension of calcium-carbonate.

Using flow through elements can accelerate deposition by providing a greater flow of nutrients to regions of the element than would be provided by diffusion alone. Such flow can also provide improved uniformity of deposition throughout the element as regions where deposition is occurring more rapidly will reduce in porosity so diverting the nutrient flow towards regions of higher porosity. This approach can enable compensation for non-uniform wall thickness or aggregate compositional variation that could otherwise create weak areas in the element under fabrication.

In some examples, as the fabrication process occurs, the porosity of the element reduces thus reducing the liquid nutrient flow (Q) for given differential pressure (P) and the pressure driving the flow may be increased in order to at least partly maintain the nutrient flow and so at least partly maintain the rate of calcium-carbonate deposition. Thus, the method of the present invention may comprise increasing the pressure driving the liquid through the element being produced as deposition occurs.

In such examples, monitoring pressure and flow across the element enables the flow resistance to be calculated and the porosity and strength of the element to be inferred. This provides a powerful feedback loop to monitor the progress of the biodeposition process and ultimately infer the endpoint at which a sufficient strength flow resistance is reached. Thus, the method of the present invention may comprise comparing resistance of the element to the flow of the liquid to a threshold to determine when at least part of the process is complete.

The flow resistance threshold value for a given construction will depend on construction element geometry, aggregate type, strength requirement and performance of porous media used and is derived empirically. For given construction element geometry and aggregate mix this can be summarised as:

Element Strength ∝1/element porosity ∝flow resistance=P/Q

In some applications where it is desirable to reduce the surface porosity towards zero, through-flow is no longer optimal and a secondary process where one or more surfaces of the element are immersed in nutrient containing liquid until the surface is sufficiently impermeable may be preferred. Such an approach can be used to achieve the highest strength and stiffness of load-bearing elements, improved visual appearance or improved properties such as on surfaces prone to wear, frost or other weathering phenomena. The reduction or elimination of surface porosity may be particularly advantageous where the construction element contains reinforced, pre-tensioned or post-tensioned steel structures. The use of reinforcement structures is discussed in greater detail below

The secondary process of reducing surface porosity may be achieved by flowing the nutrient-containing liquid over a surface or by submerging the surface in the liquid. Thus, as the porosity of the aggregate matrix is reduced by deposited calcium-carbonate such that the flow resistance of the flow of the liquid through the aggregate matrix increases, the method of the present invention may comprise creating a flow of the liquid across one or more of the surfaces of the element being produced to further reduce the porosity of the surface of the element. In other instances, the method of the present invention may comprise submerging one or more of the surfaces of the element being produced in the nutrient-containing liquid to further reduce the porosity of the surface of the element.

In some examples, the method uses structures to facilitate nutrient transfer to the interior of the element such as channels or other engineered voids through the centre of the element. In such examples, the nutrient-containing liquid can be flowed, e.g. be being pumped, through the channels or voids and the channels or voids may be lined by perforate channel guides or other perforate or porous moulds. The perforate of porous moulds may be as described previously. In some examples, the channels are also suitable for post-tensioning the element. This is advantageous in many applications, particularly slabs intended for post tensioning.

The elements that are produced using methods of the present invention may contain one or more reinforcing structures. Reinforcing structures are typically solid. The reinforcing structures may be present at the surface of the element or they may be embedded inside the element.

The reinforcing structures may take the form of rods, sheets or mesh that are placed in the aggregate matrix (i.e. macrostructures). These reinforcing structures may be made from metal (such as steel or stainless steel), ceramic, polymer or natural fibers. Steel reinforcing structures may be pre-tensioned or post-tensioned steel structures. Alternatively, the reinforcing structures may take the form of fibres. These fibres may be distributed, typically randomly, through the aggregate matrix. Fibre reinforcing structures may be made from metal (such as steel or stainless steel), glass, carbon and polymer, with glass and basalt fibres being particularly effective.

The reinforcing structures will typically be present in the aggregate matrix so that, in the method of the present invention, calcium-carbonate is deposited around the reinforcing structures. To promote high levels of adhesion between the reinforcing structures and the aggregate body of the element, the reinforcing structures may be precoated in the bacteria that is used to deposit calcium-carbonate or directly coated in calcium-carbonate. Thus, in some embodiment, the method may comprise a step of precoating the reinforcing structures in bacteria and incorporating the reinforcing structures into the aggregate matrix before precipitation of calcium-carbonate has started.

When using naturally occurring microorganisms, the following or combinations thereof may be used: Proteus vulgaris, Sporosarcina ureae, Sporosarcina Pasteurii, Sporosarcina Ureae, Bacillus Sphaericus, Myxococcus Xanthus, Proteus Mirabilis, Helicobacter Pylori, Synechocystis sp. or Synechococcus sp.

In a further refinement, bacteria are modified at a genetic level, i.e. genetically engineered. For instance, the bacteria may be modified for more rapid or otherwise modified calcium-carbonate deposition properties by techniques such as transfection, transformation, viral transduction, CRISPR, electroporation or gene-guns. Such modified bacteria can have a higher metabolism and so require a higher flow of nutrients which is enabled by the methods described herein.

The nature of the genetic modification may involve urease gene clusters that are either cut from wild-type calcium precipitating bacteria or algae or be synthetically constructed. New bacterial strains are produced by taking competent cells and modifying its gene sequences by transformation via heat-shock or electroporation, transduction or clustered regularly interspaced short palindromic repeats (CRISPR). One such example protocol would be taking top10 Escherichia coli cells, chemically treating with CaCl₂), Mn²⁺, K⁺. Co³⁺, Rb⁺, dimethyl sulfoxide and/or dichlorodiphenyltrichloroethane to increase membrane porosity and transformed via formed via heat-shock in a 42° C. heat-block and then plated and grown up in super optimal broth.

Another such protocol would include transforming guide ribonucleic acid plasmid and urease operon into Escherichia coli HB101 with temperature sensitive pSIM5 and CAS9 plasmid by heat shock at 42° C. Then the cells are electroporated at 1800V and recovered to induce the Cas9 and plated and grown up in Lysogeny broth.

Since the method of the present invention relies on bacteria, it is preferably carried out at a temperature at which the bacteria will most effectively function. The method of the present invention may be carried out at a temperature of at least 5° C., preferably at least 10° C. and more preferably at least 18° C. The method of the present invention may be carried out at a temperature of up to 50° C., preferably up to 40° C., and more preferably up to 35° C. Thus, the method of the present invention may be carried out at a temperature of from 5 to 50° C., preferably from 10 to 40° C., and more preferably from 18 to 35° C. The method of the present invention is preferably carried out without the application or removal of heat.

Oxygen is an essential nutrient for aerobic bacterial metabolism and, as such, the amount of dissolved oxygen in the nutrient-containing liquid that is flowed to the aggregate matrix can be a factor limiting the speed of the calcium-carbonate precipitation. Furthermore, as the levels of salts such as calcium-carbonate increase, the solubility of oxygen in the liquid decreases.

In order to provide bacteria with good levels of oxygen while maintaining the oxygen (and other gases) in solution, the method of the present invention may be carried out under pressure across the element being formed. This is typically achieved by applying pressure at the surface through which the nutrient-containing liquid flows out from the element being formed (in addition to the pressure of liquid that is applied at the surface through which the nutrient-containing liquid is passed into the element being formed).

The pressure at the surface through which the nutrient-containing liquid flows out from the element being formed will be less than the pressure of liquid that is applied at the surface through which the nutrient-containing liquid is passed into the element being formed in order to maintain the bulk flow of nutrient-containing liquid through the element being formed. However, when operating at large pressure differentials across the aggregate matrix and element as it forms, gases can move out of solution and create gas bubbles within the aggregate matrix creating regions that receive reduced nutrient supply and so result in weak points in the subsequent elements. Thus, the differential pressure applied between the inlet and outlet may be within 50 kPa, preferably within 20 kPa, and more preferably within 10 kPa of one another.

In addition or as an alternative to carrying out the method under pressure across the element being formed, the method may comprise adding oxygen to the nutrient-containing liquid. This means that higher than ambient concentrations of oxygen will be present in the liquid. For instance, by dissolving pure oxygen in the nutrient-containing liquid rather than air, an approximately 5-fold increase in dissolved oxygen concentration may be achieved.

The method of the present invention may be carried out for a period of at least 4 hours, preferably at least 8 hours, and more preferably at least 12 hours. The method of the present invention may be carried out for a period of up to 2 weeks, preferably up to 6 days, and more preferably up to 3 days. Thus, the method of the present invention may be carried out for a period of from 4 hours to 2 weeks, preferably from 8 hours to 6 days, and more preferably from 12 hours to 3 days.

The nutrient-containing liquid may flow through the element being formed either continuously or periodically. In periodic flow, periods of bulk flow alternate with interval periods in which the nutrient-containing liquid does not flow through the element being formed. Periodic flow is preferred as this encourages high levels of utilisation of the nutrients in the nutrient-containing liquid while still maintaining sufficient nutrient concretions throughout the element.

Each period of bulk flow may be carried out for at least 10 minutes, preferably at least 15 minutes, and more preferably at least 30 minutes. Each period of bulk flow may be carried out for up to 4 hours, preferably up to 2 hours, and more preferably up to 1 hour. Thus, each period of bulk flow may be carried out for a period of from 10 minutes to 4 hours, preferably from 15 minutes to 2 hours, and more preferably from 30 minutes to 1 hour. Fresh (i.e. undepleted) nutrient-containing liquid will typically be flowed to the element during each period of bulk flow, preferably in an amount suitable to refresh the entire volume of nutrient-containing liquid in the element being formed.

The number of periods of bulk flow may be at least 1, preferably at least 3, and more preferably at least 5. The number of periods of bulk flow may be up to 30, preferably up to 15, and more preferably up to 10. Thus, the number of periods of bulk flow may be from 1 to 30, preferably from 3 to 15, and more preferably from 5 to 10.

During the interval period, the nutrient-containing liquid is preferably held in the element being formed. During these interval periods, there is no bulk flow through the element but diffusive flow remains. The interval period may be carried out for at least 2 hours, preferably at least 3 hours, and more preferably at least 4 hours. The interval period may be carried out for up to 20 hours, preferably up to 12 hours, and more preferably up to 8 hours. Thus, the interval period may be carried out for a period of from 2 to 20 hours, preferably from 3 to 12 hours, and more preferably from 4 to 8 hours.

It has been found that particularly good results are obtained when certain flow velocities are used, particularly in embodiments where periodic flow of the nutrient-containing liquid through the element being formed is used. The flow velocity (mm/s) is the flow of nutrient-containing liquid that is passed through the element being formed (mm³/s) averaged over the cross-sectional area of the element (mm²). The cross-sectional area of the element is made up of the two dimensions that run perpendicular to the overall thickness of the element.

The flow velocity of the nutrient-containing liquid through the element being formed may be at least 0.002 mm/s, preferably at least 0.005 mm/s, and more preferably at least 0.01 mm/s. The flow velocity may be up to 0.5 mm/s, preferably up to 0.3 mm/s, and more preferably up to 0.1 mm/s. Thus, the flow velocity may be from 0.002 to 0.5, preferably from 0.005 to 0.3 mm/s, and more preferably from 0.01 to 0.1 mm/s.

During the method of the present invention, precipitation may occur preferentially on the surface through which the nutrient-containing liquid first flows into the element being formed. This can create a variation in the amount of deposited calcium-carbonate through the thickness of the element or, in other words, a more porous weaker side to the element.

Prior art methods address this issue by physically turning the sample during the precipitation process. However, this approach is not well aligned with automated manufacture, particularly of large elements. Additionally, moving a large partially set element can create fractures within the part and subsequent weakness.

Although the degree to which a weaker side is present is reduced by methods of the present invention, it may nonetheless be beneficial to further reduce this occurrence. This can be achieved by changing the surfaces through which the nutrient-containing liquid is passed to and removed from the element being created during precipitation. By changing the direction of flow of liquid, the need to physically turn a sample during the precipitation process is removed. Thus, in some embodiments, the method of the present invention comprises changing the direction of flow of nutrient-containing liquid during the method. Thus is preferably done by reversing the flow of nutrient-containing liquid, for instance such that it flows in the opposite direction.

The direction of flow may be changed once during precipitation, but is preferably changed more than once. In the periodic feeding embodiment the flow direction may be reversed for each feed.

For instance, the direction of flow may be changed, and preferably reversed, at set intervals during the method. The direction of flow may be changed at a set interval of at least 15 minutes, preferably at least 30 minutes, and more preferably at least 45 minutes. The direction of flow may be changed at a set interval of up to 12 hours, preferably up to 8 hours, and more up to 4 hours. Thus, the direction flow may be changed at a set interval of from 15 minutes to 12 hours, preferably from 30 minutes to 8 hours, and more preferably from 45 minutes to 4 hours. Alternatively, the direction of flow may be changed as a result of the flow resistance reaching a threshold (as described elsewhere herein). Where the nutrient-containing liquid flows through the element being formed periodically, then the direction of bulk flow preferably changes at the start of each period of flow.

The flow may be reversed by swapping the inlet and the outlet of the nutrient-containing liquid. Thus, the method may comprise passing the nutrient-containing liquid to the element being formed through a first surface and withdrawing the nutrient-containing liquid from the element being formed through a second surface, and reversing the flow by passing the nutrient-containing liquid to the element through the second surface and withdrawing the nutrient-containing liquid from the element through the first surface. Valves may be used to control the flow of the nutrient-containing liquid through inlets and outlets and therefore the element surfaces.

Uneven calcium-carbonate deposition across an element can also arise as a result of nutrient gradients within the element during the method of the present invention. It is therefore beneficial to periodically refresh the nutrient-containing liquid.

This can be achieved by flushing the element being formed through with excess nutrient-containing liquid to remove the (partially consumed) nutrient-containing liquid. However, this technique uses large quantities of reagents.

Preferably, the element being formed is flushed with a fluid which is not the nutrient-containing liquid. Although liquid fluids can be used, this may lead to dilution of the nutrient-containing liquid that is subsequently added. Thus, the element being formed is preferably flushed with a gas, such as air, oxygen or another gas. Flushing is carried out until the nutrient-containing liquid is removed and subsequently further nutrient-containing liquid may be added. The further nutrient-containing liquid is preferably fresh nutrient-containing liquid, but may also be the partially consumed nutrient-containing liquid that has simply been mixed to remove any concentration gradients. It will be appreciated that when the element being formed is flushed with the gas, a small amount of the nutrient-containing liquid will remain on the surfaces and in the pores in the aggregate matrix.

The flushing fluid may be passed to and removed from the element being formed through the same inlet and outlet that supplies and removes the nutrient-containing liquid. Alternatively, separate flushing fluid inlet and outlets may be used.

Flushing may be readily combined with changing the direction of flow of nutrient-containing liquid. For instance, the element being formed may be flushed at the point the flow is changed. Thus, the nutrient-containing liquid may be flowed through the element being formed in a first direction, then the element being formed may be flushed, then the nutrient-containing liquid flowed through the element being formed in a second, typically opposite, direction. If further changes to the direction of flow are carried out then flushing may take place between each change. Alternatively, flushing may be carried out between some, but not all, changes in the direction of flow.

Flushing may be readily combined with periodic flow of the nutrient-containing liquid. In these embodiments, flushing will typically be carried out before one or more periods of bulk flow, for instance before each period of bulk flow.

The present invention further provides an element that may be produced using the method of the present invention. The element comprises an aggregate matrix bound by bacterially precipitated calcium-carbonate.

### BRIEF DESCRIPTION OF THE DRAWINGS

Certain embodiments of the present invention will now be described, by way of example only, with reference to the accompanying drawings in which:

FIG. 1 schematically illustrates an example of the cross section of aggregate matrix in a construction element prior to biocementation.

FIG. 2 schematically illustrates an example of the cross section of an aggregate matrix in a construction element after a level of biocementation.

FIG. 3 schematically illustrates, in isometric view, an example of a hollow block created according to methods described herein.

FIG. 4 schematically illustrates, in plan view, an example of a hollow block created according to methods described herein.

FIG. 5 schematically illustrates, in plan view, an example of a hollow block in a bath of nutrient-containing liquid.

FIG. 6 schematically illustrates, in cross-sectional view, an example of a hollow block showing the nutrient flow through the block.

FIG. 7 schematically illustrates an example of a slab containing multiple hollow sections.

FIG. 8 schematically illustrates an example of a slab in cross section with three different nutrient feed arrangements.

FIG. 9 is a flow-chart illustrating a method of fabricating a construction element.

FIG. 10 is a flow-chart illustrating another method of fabricating a construction element.

FIG. 11 is a flow-chart illustrating another method of fabricating a construction element.

FIG. 12 is a flow-chart illustrating another method of fabricating a construction element.

FIG. 13 schematically illustrates apparatus that may be used to reverse the direction of flow of nutrient-containing liquid from a first direction (FIG. 13a) to a second direction (FIG. 14b) during fabrication of a construction element.

FIG. 14 schematically illustrates apparatus that may be used to supply (FIG. 14a) and flush (FIG. 14b) nutrient-containing liquid to and from a construction element during fabrication.

### DETAILED DESCRIPTION

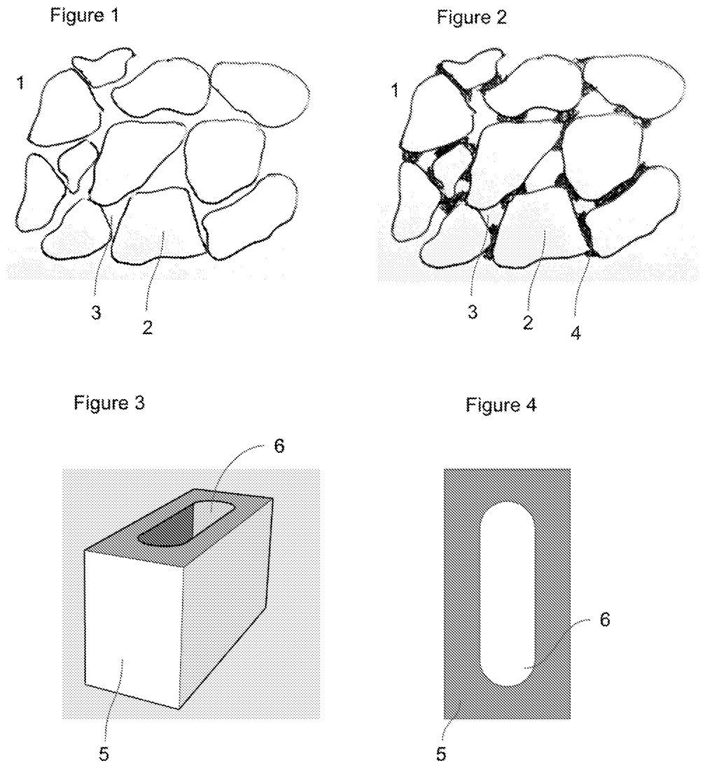

FIG. 1 shows a region of aggregate matrix 1 composed of pieces of aggregate 2 held together showing the voids 3 that make the structure porous to fluid flow. Different types of aggregate and grading can be selected to achieve the desired porosity and ultimate strength.

FIG. 2 shows the aggregate matrix 1 from FIG. 1 during biocementation where a degree of induced precipitation of calcium-carbonate is present 4. This process could be continued with the calcium-carbonate 4 further encroaching into the voids 3 achieving increased density and strength.

FIGS. 3 and 4 show different views of an example of simple finished construction element 5 produced according to the methods described herein with an internal engineered void 6.

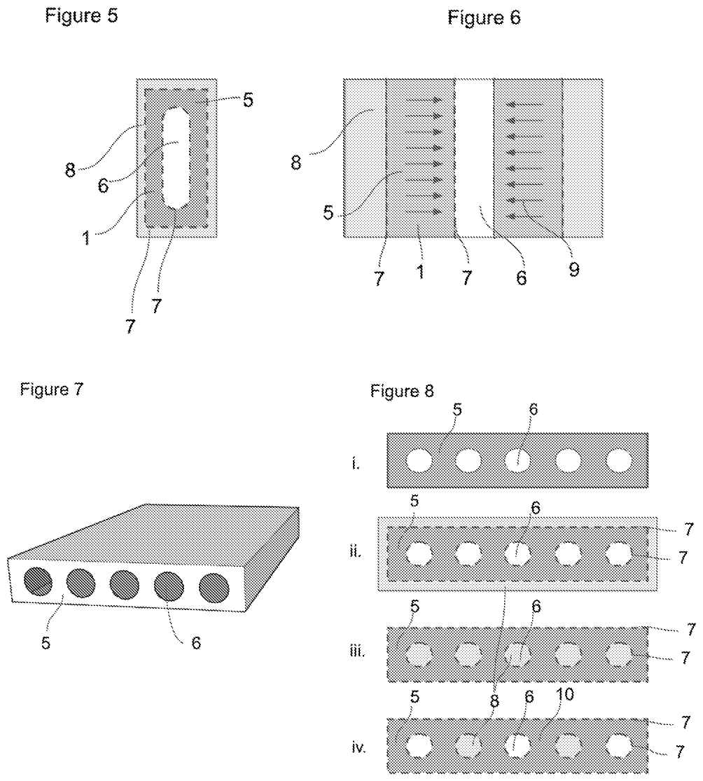

FIG. 5 shows a plan view of the construction element 5 fabricated by placing an aggregate matrix 1 in a perforate or porous mould 7 in a bath of nutrient-containing liquid 8 such that the liquid can only reach the engineered void in the centre of the construction element 6 by passing through the aggregate matrix 1.

FIG. 6 shows a cross section view highlighting how the application of pressure to the bath of nutrient-containing liquid 8 drives a fluid flow through the aggregate matrix 1 illustrated by arrows 9 to the engineered void 6 contained within the construction element 5. The pressure may be externally applied on the outside of the aggregate matrix 5 producing a pressure differential across the matrix 5 to the engineered void 6.

FIG. 7 shows an example of a construction element 5 in the form of a slab containing multiple engineered voids 6 (also referred to as channels).

FIG. 8i shows an example of the construction element 5 in the form of a slab containing multiple engineered voids 6 in cross section.

In FIG. 8ii the construction element is encased in a perforate or porous mould 7 in a bath of nutrient-containing liquid 8 and pressure from the bath, externally applied, drives a fluid flow of the liquid through the aggregate matrix that makes up the construction element 5 towards the engineered voids 6 in the centre of the element 5.

In FIG. 8iii the construction element 5 is encased in a perforate or porous mould 7 and the nutrient-containing liquid 8 is contained within the internal engineered voids 6 and pressure applied to the liquid drives a flow through the aggregate matrix that makes up the construction element 5 towards the outside surface of the element.

FIG. 8iv illustrates an additional process which may follow that illustrated in FIG. 8ii or 8iii. The construction element 5 is encased in a perforate or porous mould 7 and the nutrient-containing liquid 8 is contained within some of the internal engineered voids 6 and pressure applied to the liquid nutrients drives a flow through the aggregate matrix that makes up the construction element 5 towards both the outside surface of the element and any unpressurised engineered voids. Such a process can be advantageous as it provides nutrient flow to the aggregate media between the internal engineered voids 6 that may otherwise be a weaker point of the construction element 5.

Although not depicted in FIG. 8, a further option would be to immerse the construction element 5 encased in a perforate or porous mould 7 so that the nutrient-containing liquid surrounds the construction element 5 and fills the internal engineered voids 6. Pressure may drive a flow of liquid nutrient in a direction parallel to the internal engineered voids 6 so that the liquid nutrient flows through the voids 6 and ideally over the surface of the construction element 5. This can help to strengthen the internal and external surfaces of the construction element 5. This process may follow that illustrated in any of FIGS. 8ii-iv.

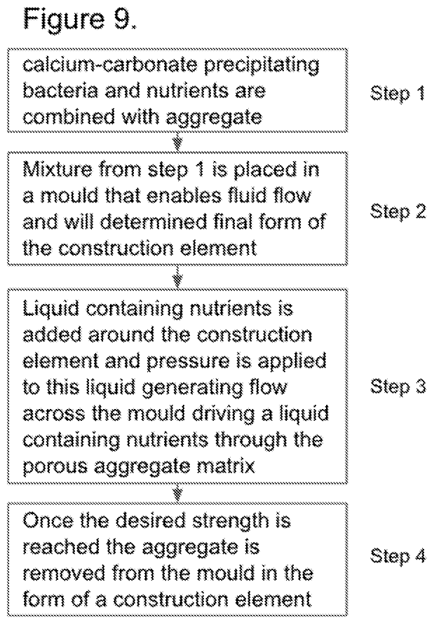

FIG. 9 illustrates an embodiment of the through-flow method of creating a construction element.

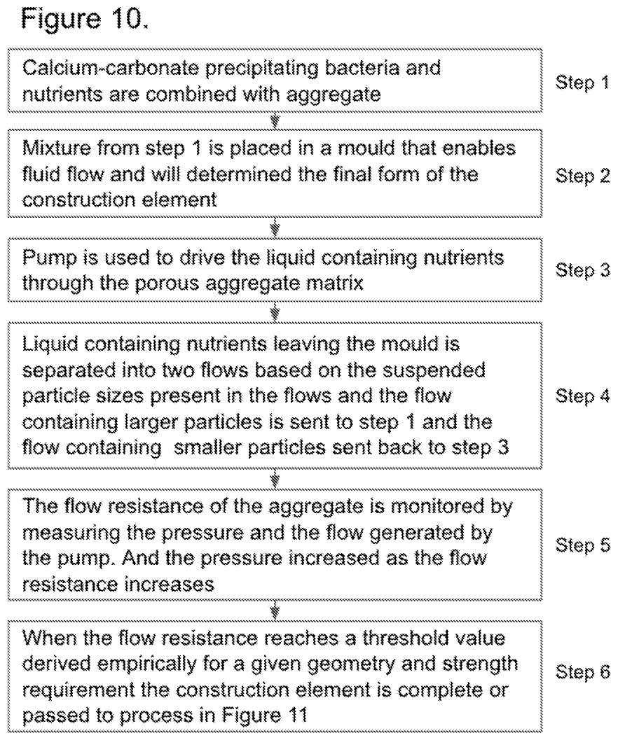

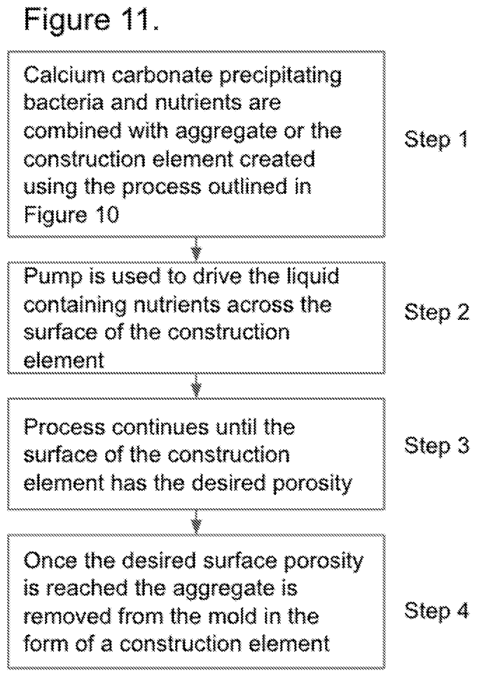

As will be appreciated, the references to steps in FIG. 9, but also FIGS. 10 to 12, do not necessarily mean that certain actions are carried out at different times from other actions or that they are carried in a particular order. However, the order that the steps are presented is generally preferred. Some steps may also be omitted in certain instances, for instance in some instances it is desirable to retain the mould as part of the element, rather than removing the element from the mould, or incorporated into other methods.

In Step 1, calcium-carbonate precipitating bacteria and nutrients are approximately dispersed through an aggregate. This may be achieved by a variety of means such as a rotary mixer or pan mixer.

In Step 2, the aggregates, bacteria and nutrients are added to a porous or perforate mould. It can be advantageous to add the bacteria to the aggregate immediately before or whilst the aggregate is being added to the mould to avoid damaging the bacteria between the mobile aggregates. To settle the aggregate and minimise both micro voids between the aggregate particulates and air bubbles it may be advantageous to settle, vibrate, shake or tap the aggregate mix at this point. The settled aggregate mix should be contained or compressed to prevent the pressure used in Step 3 from moving the aggregate grains excessively. This can be achieved in many ways and is most simply achieved by a rigid lid fixed into the top of the mould either weighted, sprung, clamped or otherwise fixed into position.

In Step 3, an excess of nutrient-containing liquid is added to a set of surfaces (e.g. one side) of the construction element and pressure is generated in this region so forcing the liquid through the porous aggregate matrix and accelerating the calcium-carbonate precipitation.

In Step 4, once the desired strength is reached, the flow is stopped and the lid removed before the constriction element is removed.

FIG. 10 illustrates another embodiment of the through-flow method of creating a construction element.

In Step 1, calcium-carbonate precipitating bacteria and nutrients are approximately dispersed through an aggregate. This may be achieved by a variety of means such as a rotary mixer or pan mixer.

In Step 2, the aggregates, bacteria and nutrients are added to a porous or perforate mould. It may be advantageous to add the bacteria to the aggregate immediately before or whilst the aggregate is being added to the mould to avoid damaging the bacteria between the mobile aggregates. To settle the aggregate and minimise both micro voids between the elements and air bubbles it is advantageous to settle, shake or tap the aggregate mix at this point. The settled aggregate mix should be contained or compressed to prevent the pressure used in the next step from moving the aggregate grains excessively. This can be achieved in many ways and is most simply achieved by a rigid lid fixed into the top of the assembly either weighted, sprung or clamped into position.

In Step 3, a pump is used to drive the nutrient-containing liquid through the construction element and the aggregate mix in a similar way to Step 3 of FIG. 9.

In Step 4, the liquid leaving the construction element is separated into two flows based on the particle sizes within the flows, and the flow containing the finer particles sent as an input to Step 3 while the flow containing the larger particles is sent as an input to in Step 1 where it is combined with the aggregate.

In Step 5, the pressure and flow rates through the construction elements are used to calculate the flow resistance of the construction element and the pressure is varied (normally increased) to maintain the flow rate.

In Step 6, when the flow resistance reaches a threshold value (or where some other suitable criterion related to the process parameters is met), the construction element is complete or passed to a secondary process as described in FIG. 11. The threshold value may be empirically derived based on the construction element's geometry strength requirement, aggregate composition and the porous or perforate media used.

FIG. 11 illustrates a flow-across element method of creating a construction element. In the present invention, this flow-across method is preferably used as a secondary process for reducing surface porosity. In Step 1, calcium-carbonate precipitating bacteria and nutrients are approximately dispersed through an aggregate. This may be achieved by a variety of means such as a rotary mixer or pan mixer or alternatively may be output of the process described in FIG. 9 or FIG. 10. In the event that the element has been pre-formed, for instance using the process described in FIG. 9 or 10, and flow-across is being used as a secondary process, Step 1 will be omitted. In Step 2, a pump creates a flow of nutrients across one or more surfaces of the construction element. In Step 3, the flow of nutrients across the surface of the construction element continues until the desired surface porosity is reached. The surface porosity can be determined (e.g. measured or predicted) in any suitable way. In Step 4, once the desired porosity is reached the construction element is removed from the mould.

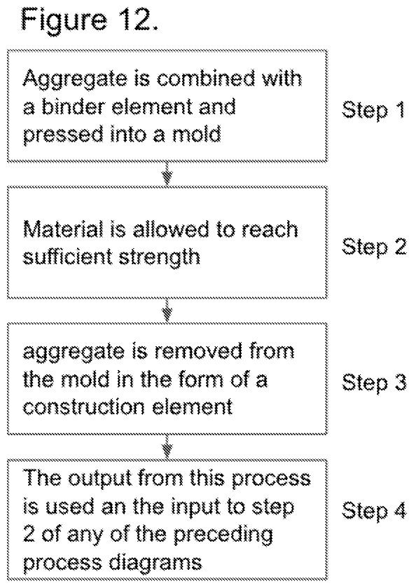

FIG. 12 illustrates another method of constraining the porous aggregate while the biocementation process occurs. In Step 1, a binder (e.g. as described in detail above) is dispersed through the aggregate and the binder and aggregate are provided in (e.g. pressed into) a mould in the shape of the desired construction element. In Step 2, the construction element is allowed to reach the desired strength. In Step 3, the aggregate is removed from the mould in the form of a construction element. In Step 4, the construction element is used as the input to Step 2 of FIG. 9, FIG. 10 or FIG. 11.

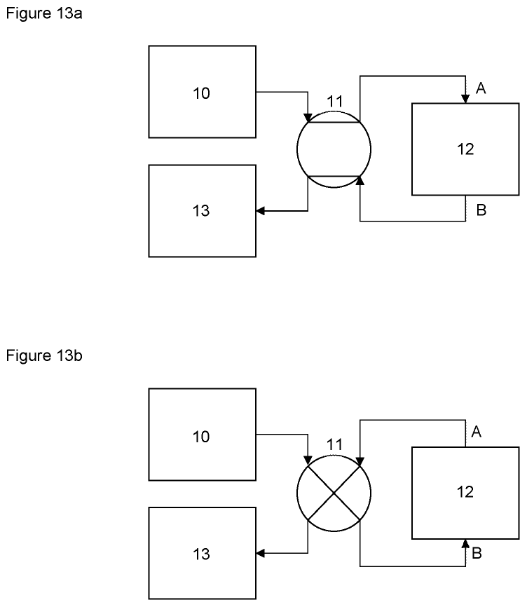

FIG. 13 schematically illustrates apparatus that may be used to reverse the direction of flow of nutrient-containing liquid during fabrication of an element, such as a construction element. In FIG. 13a, nutrient-containing liquid 10 is passed through a valve 11 which directs the liquid 10 through a first port A into the mould 12 where it flows through an element being formed to enhance the bacterial precipitation of calcium carbonate. The partially consumed nutrient-containing liquid 13 that has passed through the element being formed is withdrawn from the mould 12 through a second port B and passes through the valve 11 for further use or disposal.

Once the method of the present invention has been carried out for a period of time using the apparatus configuration shown in FIG. 13a, the element being produced will be partially created. The direction of flow of the nutrient-containing liquid 10 may then be reversed by using the apparatus in the configuration shown in FIG. 13b. In this configuration, rather than directing the nutrient-containing liquid 10 into the mould 12 through the first port A, the valve 11 switches to direct the liquid 10 through second port B into the mould 12 where it flows through the partially created element. The partially consumed nutrient-containing liquid 13 that has passed through the partially created element is withdrawn from the mould 12 through the first port A and passes through the valve 11 for further use or disposal. Thus, the nutrient-containing liquid 10 flows through the mould 12 and the element being formed in the opposite direction to that depicted in FIG. 13a.

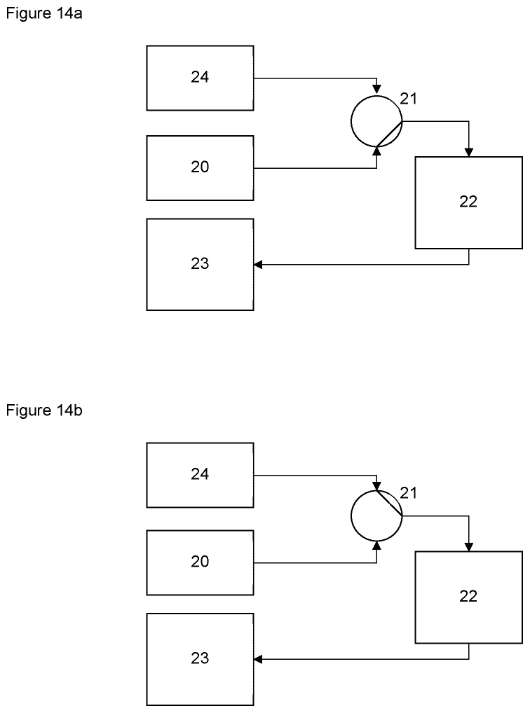

FIG. 14 schematically illustrates apparatus that may be used to flush an element, such as a construction element, during fabrication. In FIG. 14a, nutrient-containing liquid 20 is passed through a valve 21 which directs the liquid 20 into the mould 22 where it flows through an element being formed to enhance the bacterial precipitation of calcium carbonate. The partially consumed nutrient-containing liquid 23 that has passed through the element being formed is withdrawn from the mould 22 for further use or disposal.

Once the method of the present invention has been carried out for a period of time using the apparatus configuration shown in FIG. 14a, the element being produced will be partially created but a nutrient gradient may have built up inside the mould. The partially created element may then be flushed by using the apparatus in the configuration shown in FIG. 13b. In this configuration, rather than directing the nutrient-containing liquid 20 into the mould 22, the valve 21 switches to direct a gas 24 such as air into the mould 22 where it flows through the partially created element. The partially consumed nutrient-containing liquid 23 that has passed through the partially created element is expelled from the mould 22 by the gas 24, along with any nutrient gradients entrained in the consumed liquid 23. The apparatus may then be returned to the configuration shown in FIG. 14a in order that fresh nutrient-containing liquid 20 may be introduced into the mould 22.

Although described with reference to construction materials the methods described herein can be equally applied outside of the area for example in creating a range of materials such as furniture, planters, pipes, weights or sintered filter elements.

1. A method of producing an element comprising an aggregate matrix and calcium-carbonate, wherein the calcium-carbonate is precipitated by bacteria into the element being produced, the method comprising:
applying a pressure across at least part of the element being produced in order to drive a bulk flow of a liquid containing nutrients at least partly through the element to the bacteria.

2. A method according to claim 1 wherein the pressure driving the liquid through the element being produced is increased as deposition occurs, and wherein the resistance of the element to the flow of the liquid is compared to a threshold to determine when at least part of the process is complete.

3. A method according to claim 1 or claim 2 wherein one or more perforate or porous moulds allow the nutrient-containing liquid to flow through the element being formed while retaining the aggregate.

4. A method according to claim 3 wherein the one or more perforate or porous moulds are retained within the element that is produced.

5. A method according to claim 3 or claim 4 wherein the perforate or porous mould may surround at least part of the aggregate matrix and preferably the entire aggregate matrix.

6. A method according to any of claims 3 to 5 wherein the perforate or porous mould comprises a plurality of openings for the nutrient-containing liquid to pass through, wherein the openings are optionally small enough to retain the bacteria, and wherein the properties of the plurality of openings preferably vary across the surface of the element being produced to achieve either a more uniform flow through parts of the element being produced, or a higher flow through parts of the element being produced.

7. A method according to any preceding claim wherein one or more engineered voids are present within the element, wherein the engineered voids are preferably formed by positioning one or more perforate or porous moulds as defined in any of claims 3 to 6 within the aggregate matrix and element as it forms.

8. A method according to any claim 7 wherein pressure is used to drive the bulk flow of nutrient-containing liquid to or from the engineered voids through the external walls of the element.

9. A method according to any preceding claim wherein the element being produced comprises one or more channels, wherein the nutrient-containing liquid preferably flows through the channels.

10. A method according to claim 9 wherein the channels are suitable for post tensioning the element.

11. A method according to any preceding claim wherein, as the porosity of the aggregate matrix is reduced by deposited calcium-carbonate such that the flow resistance of the flow of the liquid through the aggregate matrix increases, a flow of the liquid is created across one or more of the surfaces of the element being produced to further reduce the porosity of the surface of the element.

12. A method according to any preceding claim wherein the method comprises flushing the element being produced with a gas during precipitation and subsequently resuming flow of the liquid containing nutrient to the element being produced.

13. A method according to any preceding claim wherein the method comprises flowing the nutrient-containing liquid through the element being formed periodically.

14. A method according to any preceding claim wherein the method comprises flowing the nutrient-containing liquid through the element being formed at a flow velocity of from 0.002 to 0.5, preferably from 0.005 to 0.3 mm/s, and more preferably from 0.01 to 0.1 mm/s.

15. A method according to any preceding claim wherein the pressure that is used to drive the bulk flow of nutrient-containing liquid is preferably from 1 to 100 kPa, more preferably from 5 to 50 kPa, and still more preferably from 10 to 30 kPa.

16. A method according to any preceding claim wherein the method is carried out under pressure across the element being formed.

17. A method according to any preceding claim wherein the method comprises changing the direction of flow of the liquid containing nutrients during precipitation.

18. A method according to any preceding claim wherein the liquid is separated into two flows after having flowed through at least part of the element being produced, wherein the separation is based on the particle size of the precipitate, with a waste flow and a flow fed back into the element being produced, wherein the separation is preferably carried out using a separation element corresponding to a hydrocyclone or virtual impactor.

19. A method according to claim 17 wherein the waste flow is used in the fabrication of another element being produced at an earlier stage of the bacterial precipitation of calcium-carbonate.

20. A method according to any preceding claim wherein a binder is used to partly form the aggregate into the element prior to the bacterial precipitation of the calcium-carbonate, wherein the binder is preferably selected from one or more of cement, fly ash, silica, GGBS and geopolymer, and/or comprises a waste product from a method according to claim 18.

21. A method according to any preceding claim wherein the flow of the liquid enables production of an element with a region greater than 50 mm thick, and preferably greater than 150 mm thick.

22. A method according to any preceding claim wherein the flow of the liquid enables suspended calcium-carbonate precipitate to be deposited within the porous aggregate matrix of the element being produced.

23. A method according to any preceding claim wherein the pressure generating the flow of the liquid is created hydraulically by a pump.

24. A method according to any preceding claim wherein the pressure that drives the flow of the liquid is applied so as to place one or more regions of the aggregate matrix within the element being produced under compression during biocementation.

25. A method according to any preceding claim wherein the porous aggregate matrix includes recycled aggregate and/or the calcium-carbonate producing bacteria are genetically engineered.

26. An element which is obtainable using a method according to any of claims 1 to 25.
